(19) United States
(12) Patent Application Publication
(10) Pub. No.: US 2006/0108992 A1
(43) Pub. Date: May 25, 2006

(54) System for regulating the level of an amplified signal in an amplification chain

(75) Inventors: Xavier Pruvost, Bretteville L'Orgueilleuse (FR); Jerome Brillant, Caen (FR)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., Eindhoven (NL)

(21) Appl. No.: 10/538,578

(22) PCT Filed: Dec. 2, 2003
(86) PCT No.: PCT/IB03/05594

§ 371 Date: Jun. 15, 2005

(30) Foreign Application Priority Data
Dec. 18, 2002 (FR) 02/16097

(51) Int. Cl. G05F 1/56

(52) U.S. Cl. 323/281

(57) ABSTRACT

This invention relates to a regulating system for regulating, with respect to a reference level (Vref), the level of an amplified signal (108), said regulating system comprising: -attenuation means (201) for generating an attenuated signal (202) from said amplified signal (108) according to a programmable attenuation factor, -conversion means (203) for converting said attenuated signal (202) in order to generate an output signal (204) intended to be compared with said reference level (Vref).

### FIELD OF THE INVENTION

The invention relates to a regulating system for regulating, with respect to a reference level, the level of an amplified signal in an amplification chain.

The invention has many applications, in particular in gain control systems that are used in tuners.

### BACKGROUND OF THE INVENTION

FIG. 1 shows a tuner comprising an amplification chain associated with a regulating system that is known from the prior art. This tuner allows the reception and processing of a radio-frequency (RE) signal 101 and comprises, arranged in series:

a variable-gain amplifier 102 for amplifying the radio-frequency signal 101. The amplifier 102 comprises a MOSFET amplification transistor T connected to an integration capacitor C1, and the voltage level at the terminals of said integration capacitor C1 determining the gain of the transistor T,

a selective filter 103 being dedicated to attenuate the image frequency and also the adjacent channels,

a mixer 104 for carrying out a change of frequency of the amplified input signal 101, by multiplying said amplified input signal 101 with a periodic signal generated by an oscillator 105,

an intermediate-frequency filter 106,

an intermediate-frequency amplifier 107 that outputs an amplified signal 108,

a surface wave selective filter 109,

a demodulator 110 for generating a demodulated signal 111.

The regulating system known from the prior art comprises:

a level detector 112 comprising a diode D and a capacitor C2. These two elements constitute a detector for detecting the peak amplitude of the amplified signal 108,

a switch 113 for selecting a reference level Vrefᵢ from a set of reference levels (Vref₁, . . . , Vref_{N}),

a comparator 114 for comparing the level of the signal generated by the detector 112 with the reference level Vrefᵢ. The comparator 114 generates an output current I_{AGC} that is proportional to the difference in level between the signal generated by the detector 112 and Vrefᵢ. The output of the comparator 114 is connected to the capacitor C1 of the amplifier 102 such that the current I_{AGC} charges or discharges the capacitor C1. As long as the amplified signal 108 does not have a level that is equal to the reference level Vrefᵢ, a non-zero current I_{AGC} is generated, which varies the voltage at the terminals of the capacitor C1 and thus leads to a variation in the gain of the transistor T until the output signal of the level detector 112 reaches the reference level Vrefᵢ.

These regulating means exhibit a certain number of limitations.

The comparator 114 receives on one of its inputs the reference level Vrefᵢ, which is chosen from a set of reference values. The consequence of this is that the operating point of the level detector is modified. Since the characteristics of the level detector vary as a function of the operating point, the response time of the control loop changes when different reference levels are applied to the input of the comparator.

The use of a peak amplitude detector degrades the performance of the tuner in terms of “cross-modulation” (i.e. there is an increase in the spectral interaction between a desired frequency channel and a modulated frequency spectrum), in terms of “intermodulation” (i.e. there is an increase in the spectral interaction of two frequency channels) and in terms of “pulling” (i.e. there is an increase in the sensitivity to disturbance of the oscillator 105 by radiation).

Moreover, the use of such a peak amplitude detector is restrictive in that it does not allow the level of a SECAM-modulated input signal to be regulated. This is because the detection of the peak amplitude of such an input signal having been positively modulated is not a good indicator of its level.

### SUMMARY OF THE INVENTION

It is an object of the invention to propose a new architecture for a regulating system, which overcomes the limitations of the systems known from the prior art.

For this purpose, the regulating system comprises:
attenuation means for generating an attenuated signal from said amplified signal according to a programmable attenuation factor,
conversion means for converting said attenuated signal in order to generate an output signal intended to be compared with said reference level.

By contrast with the prior art where the level of the amplified signal is selected by modifying the reference level, the level of the amplified signal is selected according to the invention by modifying the attenuation factor of the attenuation means which are placed in front of the conversion means. It is therefore the amplified signal which is directly attenuated.

In this regulating system, the output signal generated by the conversion means is always compared to the same reference level. If this comparison is carried out using a comparator, the linearity of the comparison is improved since the comparator always operates around the same operating point, which can thus be known and optimally controlled.

In a preferred embodiment, the regulating system is characterized in that:

said attenuation means comprise a network of resistances defined by a set of π-structures connected in series, each node of the π-structures being connected to a switch intended to be activated for defining said programmable attenuation factor,

said conversion means comprise processing means for generating said output signal with a level proportional to the square of the effective value of said attenuated signal.

Such structures allow for the resistances to be easily dimensioned such that the equivalent output impedance of said resistance network is identical irrespective of the attenuation factor, and therefore irrespective of the desired level for the amplified signal. It is thus possible to adapt the attenuation means and the conversion means in terms of impedance, and thus to control and optimize the behavior of the conversion means, and to do so for an amplified signal having a level that varies over a dynamic range of 15 dB.

The use of a detector for detecting the square of the effective value allows to carry out a smoothed measurement of the level of the amplified signal, without taking the rapid temporal fluctuations into account. Thus, this regulating system can be used to regulate the level of a SECAM-modulated input signal.

In a preferred embodiment, the regulating system is characterized in that the switches are intended to be activated by a command word delivered by a digital bus.

The use of switches that are activated by a command word allows to easily program the level of the amplified signal.

In a preferred embodiment, the regulating system is characterized in that it comprises a voltage comparator including an adjustable voltage/current converter, for generating an output current signal I_{AGC} being proportional to the difference between said output signal and said reference level.

This characteristic allows to easily vary the time constant of the regulating system.

The invention also relates to an integrated circuit and to a tuner comprising a regulating system of the type described above.

### BRIEF DESCRIPTION OF THE DRAWINGS

The invention will be further described with reference to examples of embodiment shown in the drawings to which, however, the invention is not restricted. In the drawings:

FIG. 1 shows a tuner comprising an amplification chain associated with a regulating system known from the prior art.

FIG. 2 shows a tuner comprising an amplification chain associated with a regulating system according to the invention.

FIG. 3 shows one embodiment of the attenuation means having a programmable attenuation factor according to the invention.

FIG. 4 shows one embodiment of the conversion means for converting an attenuated signal according to the invention.

### DESCRIPTION OF PREFERRED EMBODIMENTS

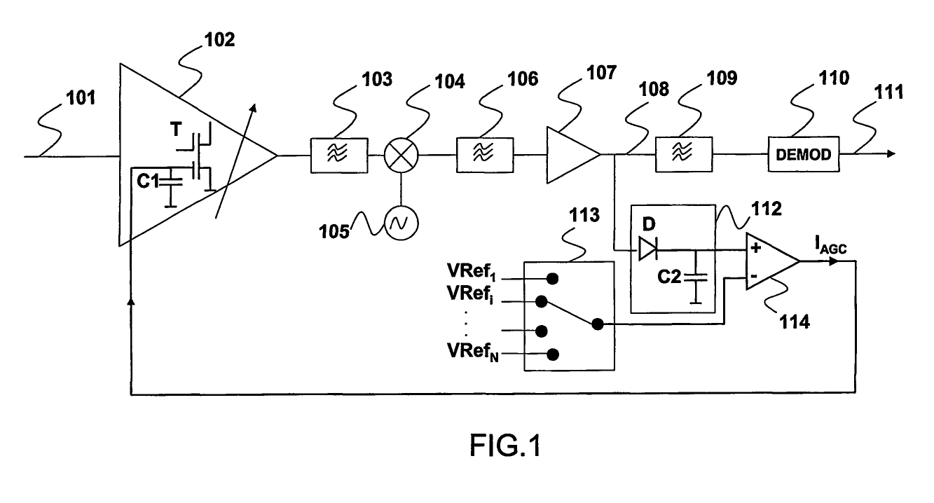

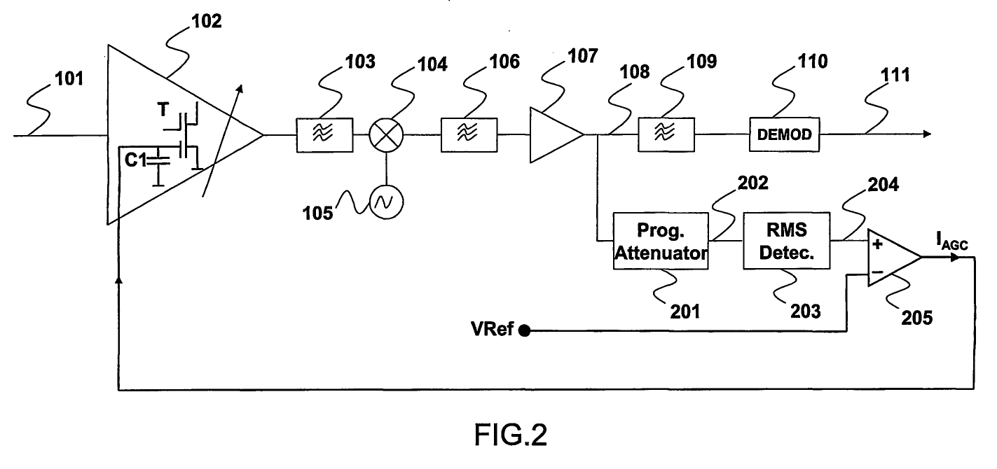

FIG. 2 shows a tuner comprising an amplification chain associated with a regulating system according to the invention. The amplification chain comprises the same elements as those described in relation to FIG. 1. The regulating system according to the invention comprises:

attenuation means 201 for generating an attenuated signal 202 from said amplified signal 108 according to a programmable attenuation factor,

conversion means 203 for converting said attenuated signal 202 in order to generate an output signal 204 intended to be compared with said reference level Vref.

A comparator 205 is used for comparing the output signal 204 and the reference level Vref. The comparator 205 generates an output current I_{AGC} that is proportional to the difference between the level of the output signal 204 and the reference level Vref. The output of the comparator 205 is connected to the capacitor C1 of the amplifier 102 such that the current I_{AGC} charges or discharges the capacitor C1. Since the level of the output signal 204 is not equal to the reference level Vref, a non-zero current I_{AGC} is generated, which varies the voltage at the terminals of the capacitor C1 and thus leads to variation in the gain of the transistor T until the output signal 204 reaches the reference level Vref. When this stable state has been reached, the level of the amplified signal 108 is attenuated with respect to the reference level Vref as a function of an attenuation factor having a value that is defined by the attenuation means 201.

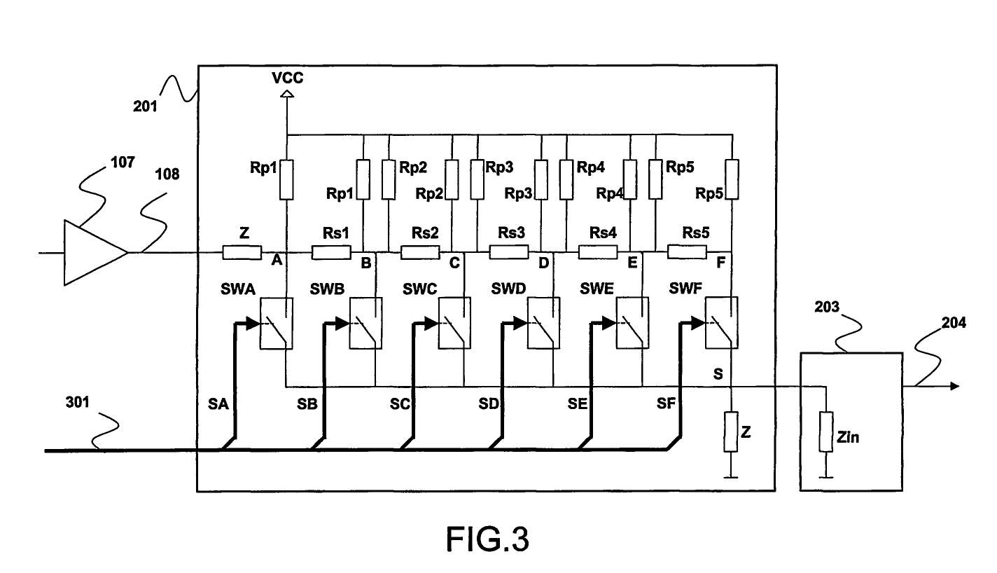

FIG. 3 shows one embodiment of the attenuation means 201 having a programmable attenuation factor according to the invention.

The attenuation means comprise a network of resistances defined by a serial connection of π-structures. Several π-structures are thus arranged in series so as to define various attenuation factors, by combining the attenuation factors of each π-structure:

a first π-structure comprises the resistance Rs1 and the two resistances Rp1,

a second π-structure comprises the resistance Rs2 and the two resistances Rp2,

a third π-structure comprises the resistance Rs3 and the two resistances Rp3,

a fourth π-structure comprises the resistance Rs4 and the two resistances Rp4,

a fifth π-structure comprises the resistance Rs5 and the two resistances Rp5.

The output of the resistance network is made at point S via the polarization resistance Z connected at the input of the conversion means 203, said conversion means having an input impedance Zin.

The resistances Rsi and Rpi (for I=1 . . . 5) of each n-structure are chosen so that the equivalent impedance seen at each node of the π-structure is equal to the equivalent impedance of the resistance network seen from the output. For this purpose, the resistances Rsi and Rpi of each π-structure are chosen such that:

$$\begin{matrix}\frac{Rsi}{Z} = 0.5 * ( {10}^{ATT / 10} - 1 ) * \sqrt{\frac{1}{{10}^{ATT / 10}}} \\ and & Eq . 1 \\ \frac{Rpi}{Z} = {( \frac{( {10}^{ATT / 10} + 1 )}{( {10}^{ATT / 10} - 1 )} - \frac{1}{Rsi} )}^{- 1} & Eq . 2\end{matrix}$$

where ATT is the attenuation factor in decibels (db) of each π-structure.

In order that each π-structure leads to an attenuation ATT close to 3 dB, a ratio of the resistances Rpi and Rsi is such that Rpi/Rsi=16. Such an integer ratio is advantageous since it can be easily implemented.

Each node (A, B, C, D, E, F) of the π-structures is connected to a switch (SWA, SWB, SWC, SWD, SWE, SWF), the activation of said switches defining said attenuation factor. Thus:

the closing of the switch A leads to an attenuation of 6 dB with respect to the level 108,

the closing of the switch B leads to an attenuation of 9 dB with respect to the level 108,

the closing of the switch C leads to an attenuation of 12 dB with respect to the level 108,

the closing of the switch D leads to an attenuation of 15 dB with respect to the level 108,

the closing of the switch E leads to an attenuation of 18 dB with respect to the level 108,

the closing of the switch F leads to an attenuation of 21 dB with respect to the level 108.

The range of attenuation of the regulating system according to the invention therefore extend over a range of 21−6=15 dB.

An attenuation of x dB carried out by the attenuation means 201 leads to an increase of x dB in the amplified signal 108.

The equivalent output impedance of the programmable attenuator 201 is identical irrespective of the attenuation factor chosen.

The switches (A, B, C, D, E, F) are advantageously activated by a command word (SA, SB, SC, SD, SE, SF) delivered by a digital bus 301, for example a bus according to the I²C standard.

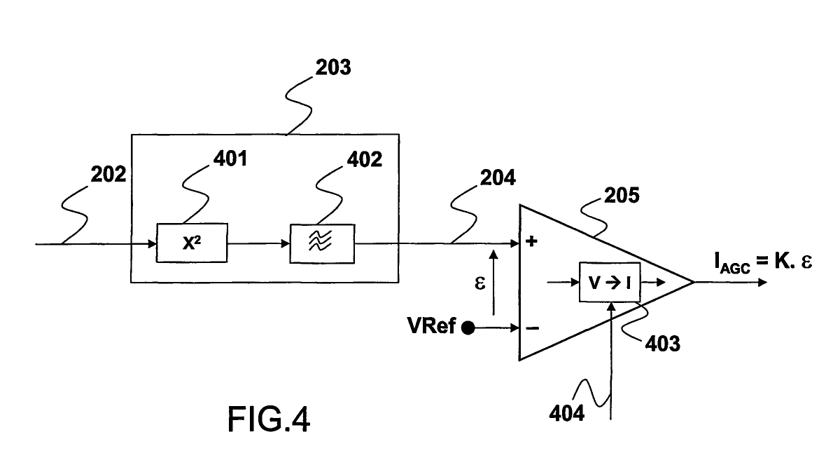

FIG. 4 shows one embodiment of the conversion means 203 for converting an attenuated signal 202 according to the invention.

The conversion means 203 comprise processing means which generate an output signal 204 that is proportional to the square of the effective value of said attenuated signal 202. For this purpose, the conversion means 203 may comprise for example, connected in series, a Gilbert cell 401 (known as such by a person skilled in the art) for generating an intermediary signal having a level proportional to the square of the attenuated signal 202, and a filter 402 applied to said intermediary signal for eliminating the 2nd order harmonics and for keeping only the low-frequency component.

The square of the effective value 204 of the attenuated signal 202 is thus compared with the reference level Vref by means of the voltage comparator 205. This comparator 205 comprises a voltage/current converter 403 for outputting an output current I_{AGC} having a value that is proportional to the difference ε between the output signal 204 and the reference level Vref. The converter 403 is thus governed by the equation:
I_{AGC}=K.ε Eq. 3

where K is a constant that can be adjusted.

The voltage/current converter 403 can advantageously be parameterized using a control signal 404 that provides information about the value of the constant K. This constant K allows to vary the time constant of the regulating system:
a low value of K leads to a high time constant (slow response of the regulating system),
a high value of K leads to a smaller time constant (rapid response of the regulating system).

Such a regulating system may advantageously be integrated in an integrated circuit, for example in an integrated circuit comprising a mixer/oscillator controlled by a phase-locked loop (PLL).

Such a regulating system may also advantageously be implemented in a tuner, such as depicted in FIG. 2, dedicated to the reception of both digital and analog radio-frequency signals, in applications using wired or wireless transmission.

1. A regulating system for regulating, with respect to a reference level (Vref), the level of an amplified signal (108), said regulating system comprising:
attenuation means (201) for generating an attenuated signal (202) from said amplified signal (108) according to a programmable attenuation factor,
conversion means (203) for converting said attenuated signal (202) in order to generate an output signal (204) intended to be compared with said reference level (Vref).

2. A regulating system as claimed in claim 1, wherein:
said attenuation means (201) comprise a network of resistances (Rp1, Rs1, Rp2, Rs2, Rp3, Rs3, Rp4, Rs4, Rp5, Rs5) defined by a set of π-structures connected in series, each node (A, B, C, D, E, F) of the π-structures being connected to a switch (SWA, SWB, SWC, SWD, SWE, SWF) intended to be activated for defining said programmable attenuation factor,
said conversion means (203) comprise processing means (401, 402) for generating said output signal (204) with a level proportional to the square of the effective value of said attenuated signal (202).

3. A regulating system as claimed in claim 2, wherein the switches (SWA, SWB, SWC, SWD, SWE, SWF) are intended to be activated by a command word (SA, SB, SC, SD, SE, SF) delivered by a digital bus (301).

4. A regulating system as claimed in one of claims 1 to 3, comprising a voltage comparator (205) including an adjustable voltage/current converter (403), for generating an output current signal I_{AGC} being proportional to the difference between said output signal (204) and said reference level (Vref).

5. An integrated circuit comprising a regulating system as claimed in one of claims 1 to 4.

6. A tuner comprising a regulating system as claimed in one of claims 1 to 4.
